(19) United States
(12) Patent Application Publication
(10) Pub. No.: US 2026/0022282 A1
(43) Pub. Date: Jan. 22, 2026

(54) ACTINIC RADIATION AND MOISTURE DUAL CURABLE EPOXY COMPOSITIONS

(71) Applicant: Dymax Corporation, Torrington, CT (US)

(72) Inventors: Aysegul Kascatan Nebioglu, Collinsville, CT (US); Ahmet Nebloglu, Collinsville, CT (US); James Aerykssen, Torrington, CT (US); Amanda Gilbert, West Hartford, CT (US)

(73) Assignee: Dymax Corporation, Torrington, CT (US)

(21) Appl. No.: 18/775,110

(22) Filed: Jul. 17, 2024

(51) Int. Cl. C09J 163/00; C08G 59/30

(52) U.S. Cl. CPC C09J 163/00; C08G 59/306

(57) ABSTRACT

Actinic radiation and moisture dual curable epoxy compositions and methods of curing such compositions are disclosed. The compositions comprise an alkoxysilane and epoxy dual functional oligomer comprising a functional group curable by actinic radiation, a functional group curable by moisture, and a functional group chemically linking the functional group curable by actinic radiation and the functional group curable by moisture; catalyst configured to react with the functional group curable by moisture in the presence of water; and at least one photoinitiator. The compositions are particularly useful for wearable electronics and medical devices. In some embodiments, unexpected results are obtained in the ability to use cationic photoinitiators and/or in avoiding the need for acrylates and/or heat curing.

### BACKGROUND OF THE INVENTION

### 1. Field of the Invention

The present invention relates to a dual curable epoxy composition capable of polymerization or cross-linking by exposure to actinic radiation and moisture. The composition is particularly useful as liquid adhesives for electronic applications.

### 2. Related Art

There is great commercial interest in producing actinic radiation curable adhesive compositions. One-part, ultraviolet (UV) and/or visible light curable, urethane adhesive compositions are known; however, portions of these compositions remain unreacted and uncured when UV or visible light is blocked and prevented from striking these adhesive compositions. These shadowed areas pose a reliability risk since a less than ideal adhesive bond is formed, and the uncured, wet or tacky adhesive may chemically solubilize or otherwise attack either or both the adjoining cured adhesive areas, or its substrate, and thus weaken the adhesive bond over time. This is an especially difficult problem in optical display assemblies and edgebonding of circuit board components. This invention is directed to an actinic radiation curable epoxy composition that can be further moisture cured in shadow areas.

WO 2012/138675 A1 and WO 2013/013589 A1 describe two-part liquid optically clear adhesive systems which contain an organic peroxide in part A and a peroxide reducing agent in part B. WO 2013/023545 A1 describes a one-part duel cure actinic radiation and heat cured liquid optically clear adhesive. In the described adhesive, a peroxide is used in the formulation that starts a curing reaction in shadow area with heat. These disclosures do not relate to moisture curable adhesives and such are not suitable for temperature sensitive components.

US 2012/0329897 A1 describes a one-part actinic radiation and moisture curable liquid composition comprising at least one component (A) with alpha-(alkoxy)silane groups, with the exception of polyolefins substituted with alpha-(alkoxy)silane groups, and at least one radiation-curing component (B) with radically curable groups, where components A and components (B) are present as separate compounds. In this composition, component (B) will stay unreacted in the shadow area because it does not have moisture curable functionality. Component (A) will stay unreacted in the areas where moisture cannot penetrate because it does not have light curable functionality. In other words the moisture curable and UV curable functionalities are not present in the same molecules.

U.S. Pat. No. 5,696,179 describes a radiation curable optical glass coating composition which utilizes an oligomer containing radiation curable functionality and silane functionality. This patent does not relate to a moisture curing formulation in shadow areas. This patent discloses a composition which is targeted to create coatings that will have better moisture resistance, low water absorption and sufficient adhesion to glass.

U.S. Pat. No. 6,777,090 describes a one component UV and heat dual curable system. In such a dual cure system the polymerizable molecule contains a primary or secondary carbamate group and at least one bond that can be activated by UV radiation. This system requires heat to cure the carbamate group.

PCT publication WO 2013/016136 describes a dual moisture curable system. The material has a part A consisting of an oligomer with UV active polymerizable groups containing isocyanate functionalities and also may contain molecules with polyisocyanate monomers or isocyanate polymers, and a second part B which contains polyol or amine functional crosslinkers. A photoinitiator may be present in either A or B. After UV cure an addition reaction between isocyanate and hydroxyl group of the polyol continues to proceed. The part of the formulation that is not exposed to UV light will be cured by the reaction of the isocyanate and polyol. PCT publication WO2013/013589 describes a two component system having UV as well as activator curing. This two component system is cured by UV and peroxide. In the shadow areas the acrylate functionality is cured by the generation of radicals by the decomposition of peroxides when it comes in contact with an amine type reducing agent and metal based salt such copper salt.

U.S. Pat. No. 9,315,695 describes an actinic radiation and moisture dual curable composition. The composition is comprised of an alkoxysilane functional polyurethane acrylate oligomer having an isocyanate group, a polyol group, a monoalcohol functional acrylate group, an alkoxysilane functional group containing a urea or thiourethane linkage, and an alkoxysilane functional group containing a urethane linkage. It does not describe dual curable epoxy compositions.

The present inventors have surprisingly discovered actinic radiation dual curable epoxy compositions. It was believed that basic oligomer components such as urethanes inhibit cationic (acidic) photoinitators used for epoxy functional groups. The present inventors have surprisingly discovered such compositions that cure through actinic radiation and moisture, while providing a better crosslinked network and curing. Moisture can be provided by dispensing and admixing water with the composition or by exposing the composition to water in the atmosphere surrounding the composition.

### SUMMARY OF THE INVENTION

The invention provides an actinic radiation and moisture dual curable composition comprising: an alkoxysilane and epoxy dual functional oligomer comprising a functional group curable by actinic radiation, a functional group curable by moisture, and a functional group chemically linking the functional group curable by actinic radiation and the functional group curable by moisture; catalyst configured to react with the functional group curable by moisture in the presence of water; and at least one photoinitiator.

The functional group curable by actinic radiation is preferably the epoxy functional group and more preferably a residue of a hydroxyl-bearing epoxidized olefin. It may be butadiene-based or isoprene-based. The functional group curable by moisture is preferably the alkoxysilane functional group and more preferably a tri-methoxysilane or a tri-ethoxysilane. The linking functional group can be part of the functional group curable by actinic radiation and/or the functional group curable by moisture or it may be a separate functional group in the molecule. Preferably, it provides an ether-linkage, and ester linkage, or, most preferably a urethane linkage.

The invention is also directed to methods of curing such actinic radiation and moisture dual curable compositions. The method involves providing water to such compositions and exposing such compositions to actinic radiation such that it at least partially polymerizes or cross-links. The actinic radiation can be ultraviolet light, visible light, electron beam radiation, or combinations of the foregoing. Moisture can be provided by dispensing and admixing water with the composition or by exposing the composition to water in the atmosphere surrounding the composition. In some embodiments of the invention, polymerization reacts less than the total number of hydroxyl groups present in the residue of the hydroxyl-bearing epoxidized olefin. Allowing some of the hydroxyl groups to remain unreacted may allow for tailoring of the oligomer's overall functionality to achieve described property targets. The ratio of alkoxysilane functional groups chemically linked to the epoxy functional group in the at least partially polymerized or cross-linked composition can be in the range of 1 to 2

### DETAILED DESCRIPTION OF PREFERRED EMBODIMENTS OF THE INVENTION

Actinic radiation and moisture dual curable epoxy composition may be comprised of a variety of components and additives. One component may be an alkoxysilane and epoxy dual functional oligomer. The alkoxysilane and epoxy dual functional oligomer may comprise from about 10 to about 90 percent by weight of the composition. An example of an alkoxysilane and epoxy dual functional oligomer is one that having the generalized structure shown below in Formula 1:

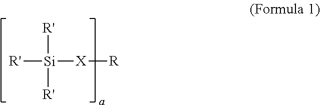

R may be the functional group curable by actinic radiation. R may be an epoxy functional group. Preferably, R may be the residue of a hydroxyl-bearing epoxidized olefin. Preferably, such olefin is derived from polybutadiene, polyisoprene, or any number of modified triglycerides such as castor oil, linseed oil, soybean oil and others known to those skilled in the art. More preferably the hydroxyl bearing, epoxidized olefin is derived from polybutadiene or polyisoprene. Examples of the epoxy functional group also include 1,3-Butadiene, homopolymer, epoxidized, hydroxy-terminated, epoxidized polypropylene glycol, epoxidized castor oil and epoxidized polysulfide.

R′ may be the functional group curable by moisture. R′ may be an alkoxysilane functional group. Preferably, such alkoxysilane functional groups may be ethoxysilane or methoxysilane, though any suitable alkoxysilane may be used. The alkoxysilane and epoxy dual functional oligomer may have one or more than one R′ components. For example, the alkoxysilane functional groups may be mono-ethoxysilane or mono-methoxysilane, di-ethoxysilane or di-methoxysilane, tri-ethoxysilane or tri-methoxysilane. Preferably, the the alkoxysilane functional groups may be tri-ethoxysilane or tri-methoxysilane. If the silane has less than three R′ components, other functional groups may be bonded with the silicon atom. Examples of R′ components include methyl dimethoxy, methyl diethoxy, trimethoxy, triethoxy, acetoxymethyldimethoxy, and acetoxypropyldimethoxy.

X may be a linking group bonding the functional group curable by actinic radiation to the functional group curable by moisture. For example, X may link an epoxy functional group to an alkoxysilane functional group. X is preferably formed by the reaction of the hydroxyl group of an epoxidized olefin (that comprises the epoxy functional group) with a functional group of an alkoxysilane. Preferably, X may be an ether, an ester, or a urethane linkage.

In the structure shown above in Formula 1, (a) may represent the number of functional groups curable by moisture and linking groups that are bonded or grafted onto the functional group curable by actinic radiation. Preferably, (a) is equal to the number of tri-alkoxysilanes bonded to an epoxidized olefin via reaction with its hydroxyl group. This number is preferably in the range of 1-2. If (a) is less than the total number of hydroxyl groups present in an epoxidized olefin, some hydroxyl will remain unreacted with the alkoxysilane. This may allow a person of ordinary skill in the art to tailor the alkoxysilane and epoxy dual functional oligomer's overall functionalization to achieve desired property targets.

An actinic radiation and moisture dual curable epoxy composition may further comprise one or more oxetane monomers. Oxetane monomer may make up from about 5 to about 50 percent by weight of the composition. Examples of oxetane monomers include 3-ethyl-3-hydroxymethyloxetane, bis[(3-ethyl-3-oxetanyl)]methyl ester, 1,4-bis[[(3-ethyl-3-oxetanyl) methoxy]methyl]benzene, 4,4′-bis[(3-ethyl-3-oxetanyl) methoxymethyl]biphenyl, 1,4-benzenedicarboxylic acid, 3-ethyl-3-(phenoxymethyl) oxetane, 3-ethyl-3-(2-ethy lhexloxymethyl)oxetane, bis[1-ethyl(3-oxetanyl)]methyl ether, 3-ethyl-3-[[3-(triethoxysilyl)propoxy]methyl]oxetane, oxetanylsilsesquioxane, and phenol novolac oxetane.

An actinic radiation and moisture dual curable epoxy composition may further comprise one or more polyols. Polyols may make up from about 1 to about 40 percent by weight of the composition. Some examples of polyols in some embodiments include polyolefin polyols like hydroxyl terminated polybutadiene, hydroxyl terminated hydrogenated polybutadiene and hydroxyl terminated hydrogenated isoprene. The polyols may have a molecular weight of from about 300 to about 10000 Daltons, preferably from about 500 to about 5000 Daltons, and more preferably from 1000 to about 4000 Daltons.

An actinic radiation and moisture dual curable epoxy composition may further comprise one or more epoxy monomers. Epoxy monomers may make up from about 0.1 to about 40 percent by weight of the composition. Examples of epoxy monomers include vinylcyclohexene dioxide, vinylcyclohexene monoxide, 3,4-epoxycyclohexylmethyl-3,4-epoxycyclohexane carboxylate, bis(3,4-epoxy-6-methylcyclohexylmethyl) adipate, bis(2,3-epoxycyclopentyl) ether, ethylene glycol bis(3,4-epoxycyclohexylmethyl) diether, dipentene dioxide, bis(3,4-epoxycyclohexyl)adipate, 2-(3,4-epoxycyclohexyl-5,5-spiro-3,4-epoxy) cyclohexanemetadioxane, 1,4-butanediol diglycidyl ether, neopentyl glycol diglycidyl ether, dicyclohexanedimethanol diglycidyl ether, trimethylol propane triglycidyl ether, glycerol triglycidy ether, and 1,3-di[2-(3,4-epoxycyclohexylethyl)]-1,1,3,3-tetramethyldisiloxane.

An actinic radiation and moisture dual curable epoxy composition may further comprise one or more epoxy functional oligomers. Epoxy functional oligomers may make up from about 0.1 to about 40 percent by weight of the composition. Examples of epoxy functional oligomers include polypropylene glycol diglycidy ether, polyethylene glycol diglycidy ether, 3,4-Epoxycyclohexylmethyl 3′,4′-epoxycyclohexanecarboxylate homopolymer, epoxidized polybutadiene, and epoxy functional silicone containing resins such as 1,3-di[2-(3,4-epoxycyclohexylethyl)]-1,1,3,3-tetramethyldisiloxane homopolymer.

An actinic radiation and moisture dual curable epoxy composition may further comprise one or more photoinitiators. Photoinitators may make up from about 1 to about 8 percent by weight of the composition. Photoiniators may be free radical photoinitiators and/or cationic photoinitiators. The one or more photoinitiators are preferably configured to react with the functional group curable by actinic radiation in the alkoxysilane and epoxy dual functional oligomer and/or with any other monomers or oligomers present in the composition. Some examples of free-radical photoinitiators in some embodiments include aromatic ketones. Preferred examples thereof include benzophenone, 2-hydroxy-2-methylpropiophenone, 1-hydroxycyclohexyl phenyl ketone, 2-Hydroxy-2-methyl-1-[4-(1-methylvinyl)phenyl]propanone homopolymer, 2,2-diethoxyacetophenone, camphorquinone, 2,2-dimethoxy-2-phenylacetophenone, methylbenzoyl formate diphenyl(2,4,6-trimethylbenzoyl)phosphine oxide, and phenylbis(2,4,6-trimethylbenzoyl)phosphine oxide. Epoxy monomers and oligomers are preferably cross-linked and/or polymerized using cationic photoinitiators. It was believed that the presence of urethanes, such as in an alkoysilane, would prevent or inhibit the functionality of cationic photoinitiators. However, the present inventors have surprisingly discovered that cationic photoinitiators may be successfully used with alkoxysilane and epoxy dual functional oligomers disclosed herein, even if such molecules comprise urethane functional groups. Examples of cationic photoinitators include diaryliodonium hexafluorophosphate, diaryliodonium hexafluoroantimonate, diaryliodonium tetrakis(pentafluorophenyl)borate, 4-octyloxyphenyl phenyliodonium hexafluoroantimonate, 4-(2-hydroxytetradecyloxyphenyl)phenyliodonium hexafluoroantimonate, 4-(1-methylethyl)phenyl 4-methyl-phenyliodonium tetrakis(pentafluorophenyl)borate, (diphenyl(4-phenylthio)phenylsulfonium hexafluoroantimonate, bis(4-(diphenyl sulfonio)phenyl)sulfide hexafluoroantimonate), and diphenyl(4-phenylthio)phenylsulfonium hexafluorophosphate, bis(4-(diphenylsulfonio)phenyl)sulfide bis(hexafluorophosphate)triphenyl sulfonium hexafluoroantimonate.

The photoinitator component may further contain a photosensitizer to transfer visible light energy to free radical and cationic photoiniators and allow compositions to cure with visible light. Some of the examples of photosensitizers include isopropyl thioxanthone, 2-chlorothioxanthone, 2,4-diethylthioxanthone, 1-chloro-4-propoxythioxanthone, isopropyl-9H-thioxanthen-9-one, 9,10-diethoxyanthracene, 9,10-dimethoxyanthracene, 9,10-dipropoxyanthracene, 9,10-dibutyloxyanthracene, 2-ethylanthraquinone, and 2-tertbutylanthraquinone.

An actinic radiation and moisture dual curable epoxy composition may further comprise one or more UV-absorbers and/or light stabilizer antioxidants. Some examples of UV-absorbers and/or light stabilizer antioxidants in some embodiments include 2-(2-Hydroxy-3,5-di-tert-amylphenyl)-2H-benzotriazole, 2-Ethoxy-2′-ethyloxalic acid bisanilide, 2,4,6-Tris[4-(1-octyloxycarbonyl)ethyloxy-2-hydroxyphenyl]-1,3,5-triazine, 2,2′-Methylenebis[4-(1,1,3,3-tetramethylbutyl)-6-(2H-benzotriazol-2-yl)phenol], 2-(2-Hydroxy-5-methacryloyloxyethylphenyl)-2H-benzotriazole, 2-(2-Hydroxy-3,5 dicumyl)benzotriazole, Bis(1,2,2,6,6-pentamethyl-4-piperidinyl) sebacate, Methyl(1,2,2,6,6-pentamethyl-4-piperidinyl)sebacate, and 4-Hydroxy-2,2,6,6-tetramethyl-1-piperidinethanol-dimethyl succinate copolymer. The amount of UV-absorbers and/or light stabilizer antioxidants in the in the actinic radiation and moisture dual curable epoxy composition may range from about 0 percent to about 3 percent by weight, preferably from about 0.1 percent to about 2 percent by weight, and more preferably from about 0.2 percent to about 1 percent by weight.

An actinic radiation and moisture dual curable epoxy composition may further comprise one or more thermal initiators. Thermal initiators may make up from about 0.1 to about 4 percent by weight of the composition. Examples of thermal initiators include Onium salts of strong acids such as sulfonium, (4-hydroxyphenyl)methyl(phenylmethyl)-, trifluorotris(1,1,2,2,2-pentafluoroethyl)phosphate, iodonium, [4-(1-methylethyl)phenyl](4-methylphenyl)-, trifluorotris(1,1,2,2,2-pentafluoroethyl)phosphate, and quaternary ammonium blocked super acid initiators such as quaternary ammonium blocked triflic acid.

An actinic radiation and moisture dual curable epoxy composition may further comprise one or more catalysts for moisture curing. Catalysts for moisture curing may make up from about 0.01 to about 3 percent by weight of the composition. The one or more catalysts for moisture curing are preferably configured to react with the functional group curable by moisture in the alkoxysilane and epoxy dual functional oligomer. Moisture can be provided by dispensing and admixing water with the composition or by exposing the composition to water in the atmosphere surrounding the composition. Some examples of catalysts for moisture curing in some embodiments include organic and inorganic acids such as acrylic acid, methacrylic acid, maleic acid, acetic acid, hydrochloric acid, and phosphoric acid and its esters, basic compounds such as triethanol amine, N,N-dimethylcyclohexylamine, 1,4-diazabicyclo[2.2.2]octane, tetramethylene guanidine (TMG), photolatent catalysts such as Solyfast™ 0010, 1,5-diazabicyclo[4.3.0]non-5-ene and its derivatives, organometallic compounds such as dibutyltindilaurate (DBTDL), dibutyltin oxide, stannous octoate, dibutyltin diacetate, bismuth neodecanoate, zinc neodecanoate and tetrabutyl titanate.

An actinic radiation and moisture dual curable epoxy composition may further comprise one or more chelating agents. Chelating agents may make up from about 0.1 to about 3 percent by weight of the composition. Preferably, the chelating agent may be a 1,3 dicarbonyl compound. Some examples of 1,3 dicarbonyl compounds in some embodiments include 2,4-pentanedione, methyl acetoacetate, dimethylmalonate, N-methylacetoacetamide, acetoacetamide, and malonamide.

An actinic radiation and moisture dual curable epoxy composition may further comprise one or more thixotropic agents. Thixotropic agents may make up from about 0.1 to about 10 percent by weight of the composition. Thixotropic agents are also known as rheology aids and affect the rheological properties of the composition, such as viscosity, stability, and shear thinning. Some examples of thixotropic agents in some embodiments include bentonite, sodium silicate, magnesium silicate, fluorine silicate, lithium silicate, silicon dioxide, fumed silicon dioxide (silica), (meth)acrylate functionalized fumed silica, polydimethylsiloxane modified silica, titanates, mineral pigments, polyacrylamide, cellulose acetate propionate (CAP), cellulose acetate butyrate (CAB), acrylamide functionalized CAB and combinations thereof.

An actinic radiation and moisture dual curable epoxy composition may further comprise one or more adhesion promoters. Adhesion promoters may make up from about 0.1 to about 10 percent by weight of the composition. Some examples of adhesion promoters in some embodiments include gamma-ethacryloxypropyltrimethoxy silane, beta (3,4 epoxycyclohexyl)ethyltrimethoxy silane, gamma-glycidoxypropyl trimethoxysilane, gamma-glycidoxypropyl triethoxysilane, vinyl trimethoxysilane, vinyl triethoxysilane, (meth)acrylic phosphonic acid esters, (meth)acrylic phosphate acid esters, (meth)acrylic acid, β-carboxyethyl acrylate, and other carboxylic acid functional acrylate esters.

In some embodiments, the composition may optionally further comprise a heat stabilizer, UV-light stabilizers, free-radical scavengers, dyes, pigments, surfactants, plasticizers, opacity-modifying agents, antioxidants, surfactants, fillers, flame retardants, and combinations thereof.

The present invention is also directed to methods of curing any of the above-disclosed actinic radiation and moisture dual curable epoxy composition. The composition may be prepared by admixing the composition components until a substantially homogenous fluid is formed. In some embodiments, the composition is formed, and applied as a coating to a substrate surface at a thickness of from about 0.0001 inch to about 0.5 inch. In other embodiments, the composition is first applied to a substrate surface as above and then attached to another substrate so that the mixture performs as an adhesive. Any suitable substrate may be used such as metals, plastics and the like. Once such a composition is provided, the method may involve providing water to the composition and/or exposing the composition to actinic radiation to at least partially polymerize or cross-link the alkoxysilane and epoxy dual functional oligomer.

Actinic radiation may comprise one or more of ultraviolet light, visible light, electron beam radiation, or combinations thereof. Preferably the actinic radiation configured to react with the photoinitiators, the functional group curable by actinic radiation in the alkoxysilane and epoxy dual functional oligomer and/or with any other monomers or oligomers present in the composition. One preferred form of actinic radiation is ultraviolet light and/or visible light. Preferably, light having a wavelength from about 200 nm to about 800 nm is used, and more preferably from about 200 nm to about 465 nm. The amount of time the composition should be exposed to actinic radiation is varied and depends on several variables, including the makeup of the composition and the particular application. Exposure times can be from 0.2 seconds to about 120 seconds. Similarly, the preferred exposure intensity varies and depends on several variables, including the makeup of the composition and the particular application. Exposure intensities may be from about 5 mW/cm² to about 5000 mW/cm².

The manner by which water (moisture) is provided to the composition also may vary and can depend on the makeup of the composition and the particular application. Moisture can be provided by dispensing and admixing water with the composition or by exposing the composition to water in the atmosphere surrounding the composition. The atmosphere can be the ambient atmosphere, which contains some amount of moisture naturally, or it can be artificially humidified. If moisture is provided by dispensing or admixing water with the composition, the amount of water provided varies and depends on several variables, including the makeup of the composition and the particular application. Added water can in some embodiments make up from about 0.1 percent to about 5 percent by weight of the composition, preferably from about 0.2 percent by weight to about 3 percent by weight and more preferably from about 0.5 percent by weight to about 1 percent by weight.

One preferred application for the compositions and methods disclosed herein is wearable electronics and medical devices. Acrylate monomers which are used in certain compositions are known to cause skin sensitivity. The actinic radiation and moisture dual curable epoxy composition disclose herein may (but do not have to be) prepared without any skin sensitizers. Another advantage of some embodiments of the compositions and methods disclosed herein is that shadow areas of the particular application that do not receive the same amount of actinic radiation as other areas of the application may be aided in curing, partially polymerizing, and/or cross-linking with moisture. While secondary curing mechanisms for light curable epoxy formulations are frequently heat curing, another advantage of some embodiments of the compositions and methods disclosed herein is that heat curing may be avoided. For certain applications, heat curing is not a desirable curing mechanism due to the heat sensitivity of certain plastic substrates and because the use of heat curing adds additional footprint to the manufacturing process.

The following non-limiting examples serve to illustrate embodiments of the invention.

### EXAMPLES

Table 1 shows four examples of several specific embodiments of the inventive actinic radiation and moisture curable compositions and a comparative composition. Inventive composition examples A, B, C, and D contain an alkoxysilane and epoxy dual functional oligomer (AEDFO). Comparative example E does not contain an AEDFO. All examples contain a cycloaliphatic epoxide (CAE), oxetane, polyol, moisture scavenger (MS), filler, photoinitiator (PI), and a catalyst.

TABLE 1

| | | | | | Comparative |
|---|---|---|---|---|---|
| | Example A | Example B | Example C | Example D | Example E |
| AEDFO | 47.9 | 40.0 | 47.9 | 67.9 | — |
| CEA | 0.5 | 43.4 | 20.5 | 0.5 | 48.4 |
| Oxetane | 42.0 | 7 | 22.0 | 22.0 | 42.0 |
| Polyol | 1.4 | 1.4 | 1.4 | 1.4 | 1.4 |
| MS | 0.5 | 0.5 | 0.5 | 0.5 | 0.5 |
| Filler | 4.0 | 4.0 | 4.0 | 4.0 | 4.0 |
| PI | 3.6 | 3.6 | 3.6 | 3.6 | 3.6 |
| Catalyst | 0.1 | 0.1 | 0.1 | 0.1 | 0.1 |

To test the compositions' moisture cure ability, the example compositions were deposited on glass-reinforced epoxy laminate (FR4) boards. The thickness of the deposited examples on the boards were 5 mils (127 microns). The physical state of the deposited examples was checked after exposing them to 50% relative humidity (R.H.) at 25° C. for 7 days or 40° C. for 3 days. The results are listed in Table 2. Examples A to D formed a solid gel indicating curing with moisture while the comparative example E stayed unchanged as viscous liquid.

TABLE 2

| | | | | | Comparative |
|---|---|---|---|---|---|
| | Example A | Example B | Example C | Example D | Example E |
| Initial | Viscous | Viscous | Viscous | Viscous | Viscous |
| | liquid | liquid | liquid | liquid | liquid |
| After 7 days | Solid gel | Solid gel | Solid gel | Solid gel | Viscous |
| @ | | | | | liquid - no |
| 25° C./50% R.H. | | | | | change |
| After 3 days | Solid gel | Solid gel | Solid gel | Solid gel | Viscous |
| @ | | | | | liquid - no |
| 40° C./50% R.H. | | | | | change |

Depth-of-cure and tack-free-cure-time of the examples are given in Table 3. For depth-of-cure testing, a 9.5 mm diameter specimen was cured in a polypropylene mold by a 405 nanometer (nm) light source with exposure to 1500 millijoule per centimeter squared (mJ/cm²) light energy. It was then released from the mold and the cure depth was measured by measuring the thickness of the solidified specimen. The tack-free time in seconds(s) is the time for a coating having a 5 mil (127 microns) thickness coating on stainless steel to become tack-free with exposure to a 405 nm LED light with a light intensity of 100 milliwatts per centimeter squared (mW/cm²). The tack-free time test is based on ASTM method C679-03 where a polyethylene film with 30 grams of weight is placed on top of the cured material. There should be essentially no materials transferred to polyethylene film from a tack-free surface when it is peeled. Inventive examples and the comparative example showed comparable or same depth-of-cure and tack-free-cure-time. This demonstrates an unexpected result, specifically that the additional moisture cure functionality of the inventive examples does not affect their light cure functionality.

TABLE 3

| | | | | | Comparative |
|---|---|---|---|---|---|
| | Example A | Example B | Example C | Example D | Example E |
| Depth of Cure | 4.2 | 3.5 | 3.6 | 3.5 | 3.6 |
| (mm) | | | | | |
| Tack-free Cure | 1 | 1 | 1 | 1 | 1 |
| Time (s) | | | | | |

Tensile properties of the light-only cured and light-and-moisture dual cured materials were measured to understand the effect of moisture curing. The results are given in Table 4. Tensile samples were made as per ASTM D638 and pulled on an Instron Model 4467 using a 200-lb load cell at a speed of 1.0 inch/min. All samples were cured with 1250 mJ/cm² UV energy. Dual-cured samples were kept at 25° C./50% R.H. for 7 days before testing. The results show tensile strength and modulus are increasing whereas elongation-at-break is decreasing with moisture curing the examples A to D. This demonstrates another unexpected result, specifically additional curing with moisture compared to light-only cured samples. Comparative example E's tensile properties do not change with exposure to moisture.

TABLE 4

| | | | | After Light and Moisture Dual | | |
|---|---|---|---|---|---|---|
| | After Light Curing | | | Curing | | |
| | Tensile | Elongation- | | Tensile | Elongation- | |
| | Strength | at-break | Modulus | Strength | at-break | Modulus |
| | (MPa) | (%) | (MPa) | (MPa) | (%) | (MPa) |
| Example A | 12 | 12 | 410 | 14 | 3 | 650 |
| Example B | 8 | 13 | 310 | 16 | 10 | 720 |
| Example C | 9 | 14 | 230 | 15 | 7 | 640 |
| Example D | 3 | 20 | 33 | 5 | 12 | 96 |
| Comparative | 18 | 2 | 1100 | 18 | 2 | 1100 |
| Example E | | | | | | |

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover disclosed embodiments, those alternatives which have been discussed above and all equivalents thereto.

What is claimed is:

1. An actinic radiation and moisture dual curable composition comprising:
an alkoxysilane and epoxy dual functional oligomer comprising a functional group curable by actinic radiation, a functional group curable by moisture, and a functional group chemically linking the functional group curable by actinic radiation and the functional group curable by moisture;
a catalyst configured to react with the functional group curable by moisture in the presence of water; and
at least one photoinitiator.

2. The composition according to claim 1 wherein the functional group curable by actinic radiation is an epoxy functional group and the functional group curable by moisture is an alkoxysilane functional group.

3. The composition according to claim 1 further comprising an oxetane monomer.

4. The composition according to claim 1 further comprising a polyol.

5. The composition according to claim 1 wherein the at least one photoinitiator is a cationic photoinitiator.

6. The composition according to claim 1 further comprising a thermal initiator, a chelating agent, a thixotropic agent, and an adhesion promoter.

7. The composition according to claim 1 wherein the functional group curable by actinic radiation is a residue of a hydroxyl-bearing epoxidized olefin.

8. The composition according to claim 7 wherein the residue of a hydroxyl-bearing epoxidized olefin is butadiene-based or isoprene-based.

9. The composition according to claim 1 wherein the functional group curable by moisture is a tri-methoxysilane or a tri-ethoxysilane.

10. The composition according to claim 1 wherein the functional group chemically linking the functional group curable by actinic radiation and the functional group curable by moisture is an ether-linkage, and ester linkage, or a urethane linkage.

11. A method of curing an actinic radiation and moisture dual curable composition comprising:
(1) providing an actinic radiation and moisture dual curable composition which comprises:
(a) an alkoxysilane and epoxy dual functional oligomer comprising a functional group curable by actinic radiation, a functional group curable by moisture, and a functional group chemically linking the functional group curable by actinic radiation and the functional group curable by moisture;
(b) a catalyst configured to react with the functional group curable by moisture in the presence of water; and
(c) at least one photoinitiator;
(2) providing water to composition; and
(3) exposing the composition to actinic radiation;
whereby the composition is at least partially polymerized or cross-linked.

12. The method according to claim 11 wherein the functional group curable by actinic radiation is an epoxy functional group and the functional group curable by moisture is an alkoxysilane functional group.

13. The method according to claim 11 wherein the actinic radiation is ultraviolet light, visible light, electron beam radiation, or combinations thereof.

14. The method according to claim 11 wherein the functional group curable by actinic radiation is a residue of a hydroxyl-bearing epoxidized olefin.

15. The method according to claim 14 wherein the residue of a hydroxyl-bearing epoxidized olefin is butadiene-based or isoprene-based.

16. The method according to claim 11 wherein the functional group curable by moisture is a tri-methoxysilane or a tri-ethoxysilane.

17. The method according to claim 11 wherein the functional group chemically linking the functional group curable by actinic radiation and the functional group curable by moisture is an ether-linkage, and ester linkage, or a urethane linkage.

18. The method according to claim 12 wherein the ratio of alkoxysilane functional groups chemically linked to the epoxy functional group in the at least partially polymerized or cross-linked composition is in the range of 1 to 2.

19. The method according to claim 14 wherein the ratio of alkoxysilane functional groups chemically linked to the epoxy functional group in the at least partially polymerized or cross-linked composition is less than the total number of hydroxyl groups present in the residue of the hydroxyl-bearing epoxidized olefin.

20. The method according to claim 11 wherein water is provided to the composition by exposing the composition to water in an atmosphere surrounding the composition.
